(19) United States
(12) Patent Application Publication
(10) Pub. No.: US 2024/0382878 A1
(43) Pub. Date: Nov. 21, 2024

(54) INTEGRATED SOLUTION FOR PROCESS INTENSIFICATION USING INLINE CONSTANTLY PRESSURIZED TANK: "ICPT"

(71) Applicant: MERCK PATENT GMBH, Darmstadt (DE)

(72) Inventors: Baptiste Balbuena, Cavaillon (FR); Sebastien Delacroix, Lingolsheim (FR); Nargisse El Hajjami, Strasbourg (FR); Paul Kaschutnig, München (DE); Josselyn Haas Durr, Breuschwickersheim (FR); Sladjana Tomic-Skrbic, München (DE)

(21) Appl. No.: 18/692,965

(22) PCT Filed: Sep. 27, 2022
(86) PCT No.: PCT/EP2022/076836

§ 371 Date: Mar. 18, 2024

(30) Foreign Application Priority Data
Sep. 28, 2021 (EP) 21306336.5

(51) Int. Cl. B01D 35/157; B01D 35/147

(52) U.S. Cl. CPC B01D 35/1573; B01D 35/1475; B01D 2201/167; B01D 2201/202

(57) ABSTRACT

Methods and procedures for operating biologics or biopharmaceutical purification protocols where disparate process steps requiring significantly different process parameters (e.g., pressure and flow rate) as continuous processes without the use of surge tanks, holding tanks or similar.

### BACKGROUND OF THE INVENTION

Processing of biologics and biopharmaceuticals requires multiple process steps including, for example, chromatography and filtration steps. Usually, steps are performed in batch mode within a purification process. This is because different steps frequently need to be run under greatly varying conditions, especially with regard to flow rates and pressures. For example, eluate from a chromatography column, which is operated at a relatively constant flow rate, often needs to be temporarily stored in a tank before being processed by the next process step. This is especially true if the next step operates under constant pressure conditions, such a many filtration steps.

In so called “continuous processes” surge tanks or holding tanks are often employed because of the varying conditions required by the disparate process steps do not allow for direct connection of the process steps. The necessity of having to use surge tanks and holding tanks in currently available systems may decrease productivity and efficiency of a production protocol.

Others in the art have attempted to address this problem. For example, Schick (Filter and Separation, December 2003, pp. 30-33 and EP 1 623 752 A2) discloses an automated method of utilizing initially a constant flow rate for filtration until a user-defined pressure limit is reached and then automatically switching to a constant pressure setting. However, this method does not ensure that a constant flow or pressure is maintained and likely would not ensure the elimination of surge or holding tanks. Further, varying the flow rate, which this system would require, could negatively impact upstream process steps.

Further, Bohonak, et al. (Biotechnology Progress, 5 Oct. 2020, 37: e3088; doi.org/10.1002/btpr.3088) disclose a system that utilizes two parallel process trains where one train is used while the other is being serviced. In other words, process flow alternates through the two trains thereby permitting continuous operation of the overall process. However, this system does not allow for the seamless fusion of different process parameters like flow rate and pressure within a process train.

What is needed in the art are methods, process systems and devices that permit the continuous operation of, for example, a constant flow process step, such as a chromatographic step, with a constant pressure step, such as filtration without the need to interrupt the process with holding, surge or storage tanks or the like.

### SUMMARY OF THE INVENTION

ICPT (Inline Constantly Pressurized Tank) allows the coupling of two purification steps not necessarily performed under the same operating conditions (e.g., constant flow and constant pressure). The present invention, in fact, provides methods, process systems and devices that couple two disparate steps: one operating under constant flow with another operating under constant pressure without the use of surge tanks and/or holding tanks (or similar), without interrupting the process or without switching/redirecting the flow of the process stream, for example, between multiple trains.

In one aspect of the present invention, a pressurized reservoir (also referred to herein as a “reservoir”) links a constant flow step (e.g., chromatography, tangential flow filtration (TFF) or single pass tangential flow filtration (SPTFF)) and a constant pressure step (e.g., viral filtration, aseptic filtration). The tank is designed and operated to receive a flow at a constant flow rate or substantially constant flow rate from one process step (for example, effluent from a chromatography column) and deliver the flow at a constant pressure or substantially constant pressure to the next process step (for example, filtration). Multiple reservoirs can be used in one production process where required or desired. The use of the methods and process systems of the present invention permits continuous operation of a biopurification production process without the added expense and footprint of surge tanks or holding tanks or the use of parallel filtration trains.

Implementation of the present invention results in a streamlined production process and results in shorter production times and a smaller footprint and, therefore, cost savings and space savings. In addition to streamlining production processes, present invention results in increased capacity of filters in the filtration step of the production process, (see, Exemplification section) which further leads to improved process productivity. While the present invention is not limited to theory, it is believed that the increase in filter capacity may be the result of a polarization across the membrane. In other words, for example, antibodies settle and form a like a mesh due to concentration gradient during filling (e.g., reversible self-aggregation, weak interaction, Van der wall, affinity interactions, etc.). The mesh may act as a “protective prefilter” by retaining other plugging compounds/molecules/viruses, etc. In support of this theory, in one run, the concentration of matter was measured at different depths in the tank. It was shown that concentration was much higher in the bottom of the tank.

In addition, in the case of ICPT of the present invention, an heterogeneous eluate coming out from, for example, an ESHMUNO® (Milliporesigma, Burlington, MA) ESHMUNO® CP-FT column is being continuously filtrated through a “virus filter.” In contrast, in a batch mode operation a given quantity of an almost homogeneous solution is filtered. With the ICPT system of the present invention, at the beginning of the filtration process eluate is less concentrated in aggregates than at the end. Since filtration is taking more time than elution post ESHMUNO® CP-FT, the reservoir is filled with eluate to a certain level and then, filtration is occurring at the same time. Thus, a gradient of aggregates concentration may be generated in the pressurized tank and may be responsible for improved filter capacities. In support of this theory, an experiment was performed with and without stirring in a prefilter reservoir; when solution was stirred creating a homogenous eluate, virus filter capacity was drastically decreased compared with the “non-stirred” process having a heterogeneous eluate.

Indeed, while the reservoir is filled with, for example, the eluate of a chromatographic column, the subsequent step is performed simultaneously over at least a large portion (e.g., over 75%, 80%, 85%, 90%, 95%, 98% or 99%) of the production process. For example, an initial delay in the simultaneous operations of filling the reservoir and operating the downstream step (e.g., a filtration step) may be necessary in order to deliver process fluid to all areas of the operation. Likewise, downstream step(s) may continue for a period of time after the upstream step(s) have completed. Thus, the present invention results in a reduced process time and an increase in filter capacity in comparison to traditional processes.

In one aspect, the present invention contemplates a method for providing a constant pressure to a filter apparatus independent of a feed stream flow rate, the method comprising: providing i) a reservoir comprising one or more fluid feed stream inlets and one or more fluid feed stream outlets and ii) a pressure source for providing and maintaining pressure in the reservoir while in operation, said pressure source comprising a both pressurized gas supply controlled by a pressure regulator and a pressure regulation valve located between, and in fluid connection with, said pressure regulator and said reservoir; wherein the fluid feed stream enters the reservoir via the one or more fluid feed stream inlets at a flow rate; wherein the reservoir is pressurized from gas supplied by the pressure source; wherein constant pressure is maintained in the reservoir when said pressure regulation valve opens to bleed off excess pressure from the gas supply line if the pressure in the reservoir exceeds a first preset pressure or closes to allow gas from the gas supply line to enter the reservoir to maintain or raise the pressure in the reservoir if the pressure in the reservoir is at or below a second preset pressure wherein said fluid feed stream exits the reservoir via the one or more fluid feed stream outlets at approximately the same flow rate as when it enters the reservoir; wherein said fluid feed stream is delivered at a constant pressure to one or more filters located downstream of the one or more reservoir outlets.

In another aspect, the present invention contemplates that the first preset pressure is lower than the second preset pressure.

In another aspect, the present invention contemplates that the gas supply is sterile.

In another aspect, the present invention contemplates that the gas supply gas is air.

In another aspect, the present invention contemplates that the first or second pressure is from approximately 4 bar and up to approximately 7 bar.

In another aspect, the present invention contemplates that the filter is a virus filter.

In another aspect, the present invention contemplates that the filter is a filter for sterilizing the fluid feed stream.

In another aspect, the present invention contemplates that the filter is a filter for concentrating the feed stream.

In another aspect, the present invention contemplates that the fluid feed stream entering the reservoir is continuous.

In another aspect, the present invention contemplates a method for filtering a fluid stream from an upstream process step, the method comprising: providing i) a fluid feed stream to be filtered from an upstream process step, ii) a reservoir maintained at a substantially constant pressure when operated and iii) a filter apparatus located downstream of the reservoir; said reservoir having i) one of more inlets for said fluid stream to enter the reservoir, ii) one or more outlets, iii) a pressurized gas supply and iv) a pressure regulation valve in fluid connection and located between the pressurized gas supply and the reservoir and, wherein said reservoir is maintained at a constant pressure independent of the flow rate of the fluid feed steam into the reservoir; wherein constant pressure is maintained in the reservoir when said pressure regulation valve opens to bleed off excess pressure from the gas supply line if the pressure in the reservoir exceeds a first preset pressure or closes to allow gas from the gas supply line to enter the reservoir to maintain or raise the pressure in the reservoir if the pressure in the reservoir is at or below a second preset pressure said reservoir outlet being in fluid communication with the filter; and, wherein said fluid feed stream from an upstream process step passes into said reservoir maintained at a constant pressure before being directed toward said filter apparatus.

In another aspect, the present invention contemplates that the first preset pressure is lower than the second preset pressure.

In another aspect, the present invention contemplates that the gas supply is sterile.

In another aspect, the present invention contemplates that the gas supply gas is air.

In another aspect, the present invention contemplates that the first or second pressure is from approximately 4 bar and up to approximately 7 bar.

In another aspect, the present invention contemplates that the filter is a virus filter.

In another aspect, the present invention contemplates that the filter is a filter for sterilizing the fluid feed stream.

In another aspect, the present invention contemplates that the filter is a filter for concentrating the feed stream.

In another aspect, the present invention contemplates that the fluid feed stream entering the reservoir is continuous.

### DESCRIPTION OF THE FIGURES

FIGS. 1A & 1B show schematic representations of two embodiments of the present invention.

FIG. 2 shows a comparison of flux decay (%) of ESHMUNO® CP-FT flow-through into VIRESOLVE® Pro filters in decoupled (squares/lower series of data points) and coupled (the ICPT process of the present invention; diamonds/upper series of data points) mode with ICPT, in function of mass throughput (g/m²) during processing of a mAb (mAb2; 150 kDa).

FIG. 3 shows a comparison of flux decay (%) of ESHMUNO® CP-FT flow-through into VIRESOLVE® Pro filters in decoupled (squares/lower series of data points) and coupled (the ICPT process of the present invention; diamonds/upper series of data points) mode with ICPT, in function of mass throughput (g/m²) during processing of a mAb (mAbu; 105 kDa).

FIG. 4 shows a comparison of normalized permeability (% LMH/psi) of ESHMUNO® CP-FT flow-through into VIRESOLVE® Pro filters in function of mass throughput (g/m²). Decoupled mode=square/lower datapoints; coupled mode (ICPT)=diamond/upper datapoints and directly coupled mode=circles/mid-level datapoints. A “directly coupled” system means a system without anything (e.g., a surge tank) between the two steps: i.e., the column outlet is directly coupled to inlet of subsequent filter.

FIG. 5 shows a schematic representation of the ICPT process system and method of the present invention. See, Exemplification, for a detailed description of the figure.

### DETAILED DESCRIPTION OF THE INVENTION

### Definitions

The term “chromatography,” as used herein, refers to any kind of technique which separates an analyte of interest (e.g., a target molecule) from other molecules present in a mixture. Usually, the analyte of interest is separated from other molecules as a result of differences in rates at which the individual molecules of the mixture migrate through a stationary medium under the influence of a moving phase, or in bind and elute processes.

The term “chromatography resin” or “chromatography media” are used interchangeably herein and refer to any kind of phase (e.g., a solid phase) which separates an analyte of interest (e.g., a target molecule) from other molecules present in a mixture. Usually, the analyte of interest is separated from other molecules as a result of differences in rates at which the individual molecules of the mixture migrate through a stationary solid phase under the influence of a moving phase, or in bind and elute processes. Non-limiting examples of various types of chromatography media include, for example, cation exchange resins, affinity resins, anion exchange resins, anion exchange membranes, hydrophobic interaction resins and ion exchange monoliths. Other chromatography media may be known to those or ordinary skill in the art at the time of filing this application and are included herein.

The term “capture step” as used herein, generally refers to a method used for binding a target molecule with a stimulus responsive polymer or a chromatography resin, which results in a solid phase containing a precipitate of the target molecule and the polymer or resin. Typically, the target molecule is subsequently recovered using an elution step, which removes the target molecule from the solid phase, thereby resulting in the separation of the target molecule from one or more impurities. In various embodiments, the capture step can be conducted using a chromatography media, such as a resin, membrane or monolith, or a polymer, such as a stimulus responsive polymer, polyelectrolyte or polymer which binds the target molecule.

The term “binding” as used herein to describe interactions between a target molecule (e.g., an Fc region containing protein) and a ligand attached to a matrix (e.g., Protein A bound to a solid phase matrix or resin), refers to the generally reversible binding of the target molecule to a ligand through the combined effects of spatial complementarity of, e.g., protein and ligand structures at a binding site coupled with electrostatic forces, hydrogen bonding, hydrophobic forces, and/or van der Waals forces at the binding site. Generally, the greater the spatial complementarity and the stronger the other forces at the binding site, the greater will be the binding specificity of a protein for its respective ligand. Non-limiting examples of specific binding includes antibody-antigen binding, enzyme-substrate binding, enzyme-cofactor binding, metal ion chelation, DNA binding protein-DNA binding, regulatory protein-protein interactions, and the like. Ideally, in affinity chromatography specific binding occurs with an affinity of about 10-4 to 10-8 M in free solution.

The term “detergent” refers to ionic and nonionic surfactants such as polysorbates (e.g. polysorbates 20 or 80); poloxamers (e.g. poloxamer 188); Triton; sodium dodecyl sulfate (SDS); sodium laurel sulfate; sodium octyl glycoside; lauryl-, myristyl-, linoleyl-, or stearyl-sulfobetaine; lauryl-, myristyl-, linoleyl- or stearyl-sarcosine; linoleyl-, myristyl-, or cetyl-betaine; lauroamidopropyl-, cocamidopropyl-, linoleamidopropyl-, myristamidopropyl-palmidopropyl-, or isostearamidopropyl-betaine (e.g. lauroamidopropyl); myristamidopropyl-, palmidopropyl-, or isostearamidopropyl-dimethylamine; sodium methyl cocoyl-, or disodium methyl oleyl-taurate; and the MONAQU ATT series (Mona Industries, Inc., Paterson, N.J.). Useful as a detergent(s) is a polysorbate, such as polysorbate 20 (TWEEN 20®) or polysorbate 80 (TWEEN 80®) or various acids, such as octanoic acid.

A “buffer” is a solution that resists changes in pH by the action of its acid-base conjugate components. Various buffers which can be employed depending, for example, on the desired pH of the buffer are described in: Buffers. A Guide for the Preparation and Use of Buffers in Biological Systems, Gueffroy, D., ed. Calbiochem Corporation (1975). Non-limiting examples of buffers include MES, MOPS, MOPSO, Tris HEPES, phosphate, acetate, citrate, succinate, and ammonium buffers, as well as combinations of these.

According to the present invention the term “buffer” or “solvent” is used for any liquid composition that is used to load, wash, elute and re-equilibrate the separation units.

When “loading” a separation column to “flow through” a target molecule, a buffer is used to load the sample or composition comprising the target molecule (e.g., an Fc region containing target protein) and one or more impurities onto a chromatography column (e.g., an affinity column or an ion exchange column). The buffer has a conductivity and/or pH such that the target molecule is not bound to the chromatography matrix and flow through the column while ideally all the impurities are bound the column.

The term “re-equilibrating” refers to the use of a buffer to re-equilibrate the chromatography matrix prior to loading the target molecule. Typically, the loading buffer is used for re-equilibrating.

The term “wash” or “washing” a chromatography matrix refers to passing an appropriate liquid, e.g., a buffer through or over the matrix. Typically, washing is used to remove weakly bound contaminants from the matrix prior to eluting the target molecule and/or to remove non-bound or weakly bound target molecule after loading.

The term “affinity chromatography matrix,” as used herein, refers to a chromatography matrix which carries ligands suitable for affinity chromatography. Typically, the ligand (e.g., Protein A or a functional variant or fragment thereof) is covalently attached to a chromatography matrix material and is accessible to the target molecule in solution as the solution contacts the chromatography matrix. One example of an affinity chromatography matrix is a Protein A matrix. An affinity chromatography matrix typically binds the target molecules with high specificity based on a lock/key mechanism such as antigen/antibody or enzyme/receptor binding. Examples of affinity matrices are matrices carrying protein A ligands like Protein A SEPHAROSE™ (GE Healthcare, Boston, MA) or PROSEP®-A (MilliporeSigma, Burlington, MA). In the processes and systems described herein, an affinity chromatography step may be used as the bind and elute chromatography step in the entire purification process.

The terms “ion-exchange” and “ion-exchange chromatography,” as used herein, refer to the chromatographic process in which a solute or analyte of interest (e.g., a target molecule being purified) in a mixt mixture, interacts with a charged compound linked (such as by covalent attachment) to a solid phase ion exchange material, such that the solute or analyte of interest interacts non-specifically with the charged compound more or less than solute impurities or contaminants in the mixture. The contaminating solutes in the mixture elute from a column of the ion exchange material faster or slower than the solute of interest or are bound to or excluded from the resin relative to the solute of interest.

“Ion-exchange chromatography” specifically includes cation exchange, anion exchange, and mixed mode ion exchange chromatography. For example, the target molecule (e.g., a target protein having an overall positive charge or positively charged regions) can bind the cation exchange chromatography resin followed by elution (e.g., using cation exchange bind and elute chromatography or “CIEX”) or can predominately bind the impurities while the target molecule “flows through” the column (cation exchange flow through chromatography FT-CIEX). Anion exchange chromatography the target molecule (e.g., a target protein having an overall negative charge or negatively charged regions) can bind anion exchange resin followed by elution or can predominately bind the impurities while the target molecule “flows through” the column, also referred to as negative chromatography. In some embodiments and as demonstrated in the Examples set forth herein, the anion exchange chromatography step is performed in a flow through mode. As is known to one of skill in the art, column chromatography conditions (e.g., pH) may affect target molecule charge characteristics.

The term “ion exchange matrix” refers to a matrix that is negatively charged (i.e., a cation exchange media) or positively charged (i.e., an anion exchange media). The charge may be provided by attaching one or more charged ligands to the matrix, e.g., by covalent linkage. Alternatively, or in addition, the charge may be an inherent property of the matrix (e.g., as is the case of silica, which has an overall negative charge).

Mixed mode anion exchange materials typically have anion exchange groups and hydrophobic moieties. Suitable mixed mode anion exchange materials are CAPTO® Adhere (GE Healthcare).

The term “anion exchange matrix” is used herein to refer to a matrix which is positively charged, e.g., having one or more positively charged ligands, such as quaternary amino groups, attached thereto Commercially available anion exchange resins include DEAE cellulose, QAE SEPHADEX™ and FAST Q SEPHAROSE™ (GE Healthcare, Boston, MA). Other exemplary materials that may be used in the processes and systems described herein are FRACTOGEL® EMD TMAE, FRACTOGEL® EMD TMAE HIGHCAP, ESHMUNO® Q and FRACTOGEL® EMD DEAE (MilliporeSigma, Burlington, MA).

The term “cation exchange matrix” refers to a matrix which is negatively charged, and which has free cations for exchange with cations in an aqueous solution contacted with the solid phase of the matrix. A negatively charged ligand attached to the solid phase to form the cation exchange matrix or resin may, for example, be a carboxylate or sulfonate. Commercially available cation exchange matrices include carboxy-methyl-cellulose, sulphopropyl (SP) immobilized on agarose (e.g., SP-SEPHAROSE FAST FLOW™ or SP-SEPHAROSE HIGH PERFORMANCE™, from GE Healthcare, Boston, MA) and sulphonyl immobilized on agarose (e.g., S-SEPHAROSE FAST FLOW™ from GE Healthcare). Preferred is FRACTOGEL® EMD SO3, FRACTOGEL® EMD SE HIGHCAP, ESHMUNO® S and FRACTOGEL® EMD COO (MilliporeSigma, Burlington, MA).

The term “equilibrium buffer” refers to a solution or reagent used to neutralize conditions or otherwise bias target molecules to effectively interact with a ligand within a chromatography column or bioreactor. For example, buffer solutions described herein are capable of keeping the pH of biological systems nearly constant while chemical changes are occurring. In some examples according to embodiments of the disclosure, the pH is maintained by the equilibrium buffer nearly constant despite the biological systems having a pH between, for example, 7.0 to 10.0.

The term “elution buffer” refers to a buffer or reagent used to take off or elute product that is bound to a chromatographic media. For example, an elution buffer may be capable of eluting empty AAV (adeno-associated virus) particles during a first elution and full AAV particles during a second elution, thereby allowing the concentration of full AAV particles.

The term “effluent” refers to a component that is mobile, i.e., leaving, during chromatography processes, a.k.a., an eluate, e.g., using constant composition of elution buffer without increasing or decreasing buffer composition.

The term “isocratic elution conditions” refers to a condition of constant composition of elution buffer during chromatography processes.

The term “gradient elution conditions” refers to a condition of varying composition, for instance, by a mixing of two or more buffers, of elution buffer during chromatography processes, e.g., forming a gradient of elution buffer from 0-100% buffer in a specific time and/or during a plurality of column volumes.

Chromatography can be operated in any of three modes: (1) batch mode, where the media is loaded with target protein, loading is stopped, media is washed and eluted, and the pool is collected; (2) semi-continuous mode, where the loading is performed continuously, while the elution is intermittent (e.g., in case of continuous multicolumn chromatography); and (3) full “continuous mode,” where both loading and elution are performed continuously. U.S. patent application US 2013/0280788 (incorporated herein in its entirety) describes embodiments of what is referred to as a continuous chromatography method and apparatus, employing several chromatography columns in turn and sequentially. Continuous chromatography can be part of a “continuous process” purification procedure or operation.

The term “continuous process” or “contiguous process,” as used interchangeably herein, refers to a process for purifying a target molecule, which includes two or more process steps (or unit operations), such that the output from one process step flows directly into the next process step in the process, without interruption, and where two or more process steps can be performed concurrently for at least a portion of their duration. In other words, in case of a continuous process, as described herein, it is not necessary to complete a process step before the next process step is started, but a portion of the sample is always moving through the process steps. The term “continuous process” also applies to steps within a process step, in which case, during the performance of a process step including multiple steps, the sample flows continuously through the multiple steps that are necessary to perform the process step. One example of such a process step described herein is the flow through purification step which includes multiple steps that are performed in a continuous manner, e.g., flow-through activated carbon followed by flow-through AEX media followed by flow-through CEX media followed by flow-through virus filtration.

The term “semi-continuous process,” as used herein, refers to a generally continuous process for purifying a target molecule, where input of the fluid material in any single process step or the output is discontinuous or intermittent. For example, in some embodiments according to the present invention, the input in a process step (e.g., a bind and elute chromatography step) may be loaded continuously; however, the output may be collected intermittently (for example, in a surge tank or pool tank), where the other process steps in the purification process are continuous. Accordingly, in some embodiments, the processes and systems described herein are “semi-continuous” in nature, in that they include at least one unit operation which is operated in an intermittent matter, whereas the other unit operations in the process or system may be operated in a continuous manner.

The term “connected process” refers to a process for purifying a target molecule, where the process comprises two or more process steps (or unit operations), which are in direct fluid communication with each other, such that fluid material continuously flows through the process step in the process and is in simultaneous contact with two or more process steps during the normal operation of the process. It is understood that at times, at least one process step in the process may be temporarily isolated from the other process steps by a barrier such as a valve in the closed position. This temporary isolation of individual process steps may be necessary, for example, during start up or shut down of the process or during removal/replacement of individual unit operations. The term “connected process” also applies to steps within a process step, e.g., when a process step requires several steps to be performed in order to achieve the intended result of the process step. One such example is the flow-through purification process step, as described herein, which may include several steps to be performed in a flow-through mode, e.g., activated carbon, anion exchange chromatography, cation exchange chromatography and virus filtration.

The term “fluid communication,” as used herein, refers to the flow of fluid material (liquid or gas) between two process steps or flow of fluid material between steps of a process step, where the process steps are connected by any suitable means (e.g., a connecting line or surge tank), thereby to enable the flow of fluid from one process step to another process step. In some embodiments, a connecting line between two-unit operations may be interrupted by one or more valves to control the flow of fluid through the connecting line.

The terms “purifying,” “purification,” “separate,” “separating,” “separation,” “isolate,” “isolating” or “isolation,” as used herein, refer to increasing the degree of purity of a target molecule from a sample comprising the target molecule and one or more impurities. Typically, the degree of purity of the target molecule is increased by removing (completely or partially) at least one impurity from the sample. In some embodiments, the degree of purity of the target molecule in a sample is increased by removing (completely or partially) one or more impurities from the sample by using, e.g., a chromatography process, as described herein. In another embodiment, the degree of purity of the target molecule in a sample is increased by precipitating the target molecule away from one or more impurities in the sample. The term “pI” or “isoelectric point” of a polypeptide, as used interchangeably herein, refers to the pH at which the polypeptide's positive charge balances its negative charge. pI can be calculated from the net charge of the amino acid residues or sialic acid residues of attached carbohydrates of the polypeptide or can be determined by isoelectric focusing.

The term “pH” is known in the art to refer to a measure of hydrogen ion concentration in a liquid. It is a measure of the acidity or alkalinity of a solution. The equation for calculating pH was proposed in 1909 by Danish biochemist Peter Lauritz Sørensen:

pH=−log[H+]

where log is the base-10 logarithm and [H+] stands for the hydrogen ion concentration in units of moles per liter solution. The term “pH” comes from the German word “potenz,” which means “power,” combined with H, the element symbol for hydrogen, so pH is an abbreviation for “power of hydrogen.”

The term “process parameter,” as used herein as conditions used in a purification process. These process parameters may be monitored with, for example, one or more sensors and/or probes. Examples of process parameters are temperature, pressure pH, conductivity, dissolved oxygen (DO), dissolved carbon dioxide (DCO₂), mixing rate and flow rate. The sensor may also be an optical sensor in some cases. The sensor may be connected to an automatic control system for adjusting a process parameter.

The term “conductivity,” as used herein, refers to the ability of an aqueous solution to conduct an electric current between two electrodes. In solution, the current flows by ion transport. Therefore, with an increasing amount of ions present in the aqueous solution, the solution will have a higher conductivity. The unit of measurement for conductivity is milliseimens per centimeter (mS/cm or mS), and can be measured using a commercially available conductivity meter (e.g., sold by Orion). The conductivity of a solution may be altered by changing the concentration of ions therein. For example, the concentration of a buffering agent and/or concentration of a salt (e.g., NaCl or KCl) in the solution may be altered in order to achieve the desired conductivity. In some embodiments, the salt concentration of the various buffers is modified to achieve the desired conductivity. In some embodiments, in processes where one or more additives are added to a sample load, if one or more wash steps are subsequently used, such wash steps employ a buffer with a conductivity of about 20 mS/cm or less.

The term “salt,” as used herein, refers to a compound formed by the interaction of an acid and a base. Various salts which may be used in various buffers employed in the methods described herein include, but are not limited to acetate (e.g., sodium acetate), citrate (e.g., sodium citrate), chloride (e.g., sodium chloride), sulphate (e.g., sodium sulphate), or a potassium salt.

The terms “bind and elute mode” and “bind and elute process,” as used herein, refer to a separation technique in which at least one target molecule contained in a sample (e.g., an Fc region containing protein) binds to a suitable resin or media (e.g., an affinity chromatography media or a cation exchange chromatography media) and is subsequently eluted.

The terms “flow-through process,” “flow-through mode” and “flow-through operation,” as used interchangeably herein, refer to a separation technique in which at least one target molecule (e.g., an Fc-region containing protein such as an Fc containing fusion protein or an antibody) contained in a biopharmaceutical preparation along with one or more impurities is intended to flow through a material, which usually binds the one or more impurities, where the target molecule usually does not bind (i.e., flows through).

The term “process step” or “unit operation,” as used interchangeably herein, refers to the use of one or more methods or devices to achieve a certain result in a purification process. Examples of process steps or unit operations which may be employed in the processes and systems described herein include, but are not limited to clarification, bind and elute chromatography, virus inactivation, flow-through purification, filtration and formulation. It is understood that each of the process steps or unit operations may employ more than one step or method or device to achieve the intended result of that process step or unit operation. For example, in some embodiments, the clarification step and/or the flow-through purification step, as described herein, may employ more than one step or method or device to achieve that process step or unit operation. In some embodiments, one or more devices which are used to perform a process step or unit operation are single-use devices and can be removed and/or replaced without having to replace any other devices in the process or even having to stop a process run.

The term “surge tank” or “holding tank” or similar, are used interchangeably herein, refer to any container or vessel or bag, which is used between process steps or within a process step (e.g., when a single process step comprises more than one step); where the output from one step flows through the surge tank onto the next step. Accordingly, a surge tank is different from a “pool tank,” in that it is not intended to hold or collect the entire volume of output from a step; but instead enables continuous flow of output from one step to the next. By definition and as understood herein, a surge tank (or holding tank or similar) is at ambient pressure or near ambient pressure. It is not an integral step in the purification process in that it does not contribute to the overall efficiency of the process. Rather, a surge tank (or similar) interrupts one or more process parameters, for example, flow rate and/or pressure. In some aspects of the present invention, the use of a surge tank, holding tank, pooling tank, or similar, is expressly excluded from the present invention.

In some embodiments, the volume of a surge tank used between two process steps or within a process step in a process or system described herein, is no more than 25% of the entire volume of the output from the process step. In another embodiment, the volume of a surge tank is no more than 10% of the entire volume of the output from a process step. In some other embodiments, the volume of a surge tank is less than 35%, or less than 30%, or less than 25%, or less than 20%, or less than 15%, or less than 10% of the entire volume of a cell culture in a bioreactor, which constitutes the starting material from which a target molecule is to be purified.

The term “reservoir” or “pressurized reservoir” are considered synonyms herein and refer to process tanks that operate under a constant pressure or substantially constant pressure i.e., a pressure that is greater than ambient pressure and at a pressure that is the same as or substantially the same as a pressure that is needed in a downstream process step, for example, a downstream filtration step. A reservoir in the present invention is not the same as a surge tank (or similar) in that they perform distinctly different functions: i.e., a surge tank merely holds a process solution between process steps while a reservoir is an integral part of the purification process providing, for example, the constant pressure necessary for a downstream process step while not hindering the constant flow of an upstream process step. As discussed, above, a surge tank (or similar) interrupts one or more process parameters such as flow or pressure while the reservoir of the present invention maintains constant process parameters.

The term “filter” as used herein may include, but is not limited to one or more porous materials such as membranes, sheets, filters, filter elements, filtration media, and combinations thereof. The filters may be pleated, flat, spirally wound, and combinations thereof. The filters may be a single layered or multilayered membrane device, and may be used for filtration of unwanted materials including contaminants such as infectious organisms and viruses, as well as environmental toxins and pollutants that could be removed by size exclusion and chemical or physical adsorption of the combination thereof. The filter material may be comprised of any suitable material, including, but not limited to polyether sulfone, polyamide, e.g., Nylon, cellulose, polytetrafluoroethylene, poly sulfone, polyester, poly vinylidene fluoride, polypropylene, a fluorocarbon, e.g., poly (tetrafluoroethylene-co-perfluoro(alkyl vinyl ether)), poly carbonate, polyethylene, glass fiber, polycarbonate, ceramic, and metals.

### Operating Conditions

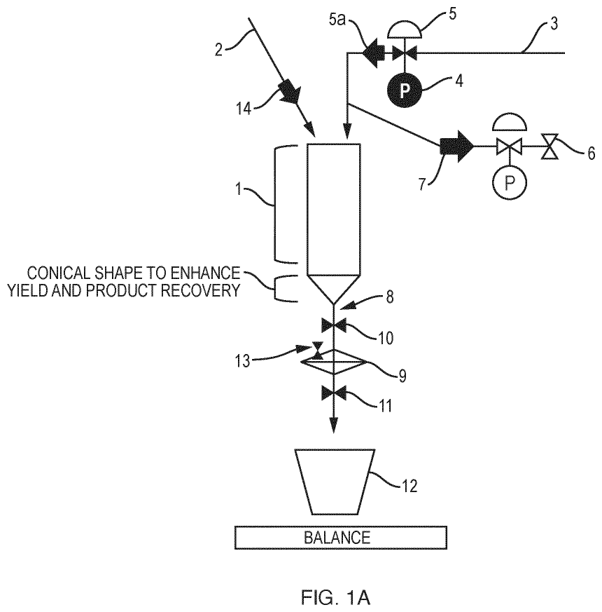

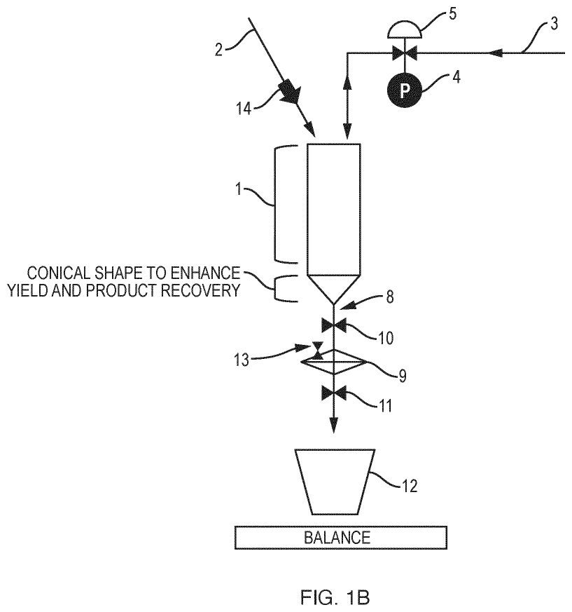

FIG. 1A shows a schematic diagram of an embodiment of the present invention. The figure is representative and one of ordinary skill in the art, armed with the teachings of this specification, would be able to develop variations of this setup.

The reservoir 1 has at least one feed inlet 2, a pressurized gas supply 3, at least one gas supply inlet 4, a first pressure regulator 5 and downstream of the first pressure regulator a one-way valve 5a located between and in fluid communication with the pressurized gas supply and the reservoir, a second pressure regulator 6 in fluid communication with the gas supply line to the gas supply inlet and downstream of the first pressure regulator, and a feed stream exit 8. There is a one-way valve 7 (arrow) located upstream of the second pressure regulator to prevent back flow. Further, one or more filters 9 (for example, a virus filter or sterilizing filter) located on the feed stream exit and in fluid communication with the reservoir, an inlet valve 10 and an outlet valve 11 located upstream and downstream of the filter, respectively, and a collection device 12 for collecting filtrate. The filter may have a filter vent 13. The feed stream inlet line is a one-way valve (i.e., a check valve) 14 to prevent back flow.

FIG. 1B shows a schematic diagram of a second embodiment of the present invention. The figure is representative and one of ordinary skill in the art, armed with the teachings of this specification, would be able to develop variations of this setup.

This embodiment is similar to the embodiment described above however it does not require the second pressure regulator (element 6 of FIG. 1A) or one-way valve located upstream of the second pressure regulator (element 7 of FIG. 1A). All of the other numbering of the elements remains the same as FIG. 1A.

Thus, the reservoir 1 has at least one feed inlet 2, a pressurized gas supply 3, at least one gas supply inlet 4, a pressure regulator 5 and downstream of the pressure regulator without a one-way valve located between the pressurized gas supply and the reservoir allowing for two-way flow in this line (see, arrows indicating two-way flow), and a feed stream exit 8. Further, one or more filters 9 (for example, a virus filter or sterilizing filter) located on the feed stream exit and in fluid communication with the reservoir, an inlet valve 10 and an outlet valve 11 located upstream and downstream of the filter, respectively, and a collection device 12 for collecting filtrate. The filter may have a filter vent 13. The feed stream inlet line is a one-way valve 14 to prevent back flow.

One advantage of this setup is a simplification of the required equipment since the second pressure valve and pressure regulator are not needed. That is this set up in FIG. 1B is lighter in terms of hardware/tubing/parts and hence cheaper and easier to set up, as compared with the first version. However, depending on the use, the greater control afforded by the set up represented in FIG. 1A may be desired.

### Operation

Here we discuss a representative operation of the system. One of skill in the art will understand, armed with the teachings of this specification in view of the knowledge of one of ordinary skill in the art, that alternative modes of operation of the system of the present invention may be possible and contemplated and are incorporated herein.

The system is operated, in one aspect, as follows. Liquid from a source flows into the reservoir at a constant or substantially constant flow rate through a feed stream inlet. “Substantially constant flow” is defined herein as within +25%, 20%, 15%, 10%, 5%, 2% or 1% of the desired flow rate. The inlet flow rate into the reservoir will be lower than the exit flow rate out of the reservoir. Since the reservoir may be “prefilled” to a desired level prior to the start of filtration the reservoir does not run dry. Further, if necessary, filtration may be temporarily halted to increase reservoir volume.

The reservoir is pressurized with gas from the supply and regulated by the first pressure regulator. The pressure used is determined by the filter employed. Some filters may require greater or lesser pressures for operation. In one embodiment, the pressure is set at 7 bar although it can be lower or higher depending on capabilities of the process setup. It is contemplated that the pressure is at least about 4 bar. The pressures used may be altered for a particular process run (i.e., higher or lower) or for particular available process resources. One of ordinary skill in the art will be able to determine the correct pressures with the guidance of this specification. In another embodiment, the pressure regulator allows only to decrease the pressure Thus, the pressure supply must be higher (or at least equal) to the process pressure.

The pressure may be altered during a process run, for example, if the filter starts to plug. “Constant pressure” and “maintaining constant pressure,” in the context of the present invention, means the desired pressure and maintaining the desired pressure (i.e., the pressure set by the operator) at any point in a production run and not that the pressure cannot be reset to a different desired pressure during the production run. A “substantially constant pressure” is defined herein as within +25%, 20%, 15%, 10%, 5%, 2% or 1% of the desired pressure.

In an aspect of the present invention, the pressure in the reservoir is maintained via the second valve. Even though the flow rates into and out of the reservoir may be equal or near equal, variations in the level of fluid in the reservoir may still happen causing variations in pressure if the pressure is not properly regulated. Further, as the filter(s) plug with usage, the pressure in the reservoir may rise if not properly regulated. This could adversely impact flow rate and, therefore, upstream processes. The second valve is set such that if the pressure in the reservoir rises above a set value, the second valve opens to lower the pressure in the reservoir by bleeding off pressure from the gas supply. Likewise, if the pressure in the reservoir is at or below the set pressure the second valve will close or stay closed so that the pressure in the reservoir will rise or be maintained.

In another aspect of the invention only one pressure regulator is employed. The one regulator may be located on the gas supply feed line similar to the first regulator in a dual regulator system, or may be located where the second regulator is located in a dual regulator system. Still, while pressure regulation in a system employing one regulator is functional and an aspect of the present invention, it may not regulate pressure as precisely as in a system where two regulators are employed.

In yet another aspect of the present invention, the present invention may couple other process parameters or a different order of process parameters. For example, it is contemplated that the present invention may couple an upstream constant pressure step with a downstream constant flow rate step.

For example, it is contemplated to connect the ICPT system of the present invention to SPTFF (or a TFF) or other filtering step. It this situation, the retentate pressure won't be set with a pressure control valve but with the pressure sensor in the tank (ICPT). The setup allows for the coupling of a constant flow with a constant pressure or a constant pressure with a (different) constant pressure for example, to empty the tank. It should also be feasible to connect the outlet of a constant pressure step to the ICPT which will be then connected (outlet) to a constant flow step, using a non-passing pump, e.g., a peristatic pump. The pressure of this second step is determined by the pressure of the tank plus the pressure generated by the pump.

In an exemplary embodiment, the chromatography (first step) and filtering steps (second Step) end simultaneously or substantially simultaneously; for example, within seconds of each other, with in less than a minute of each other, less than two minutes of each other or with less than three minutes of each other, depending on the size of the system.

### Exemplification

### ICPT: Inline Constantly Pressurized Tank Process

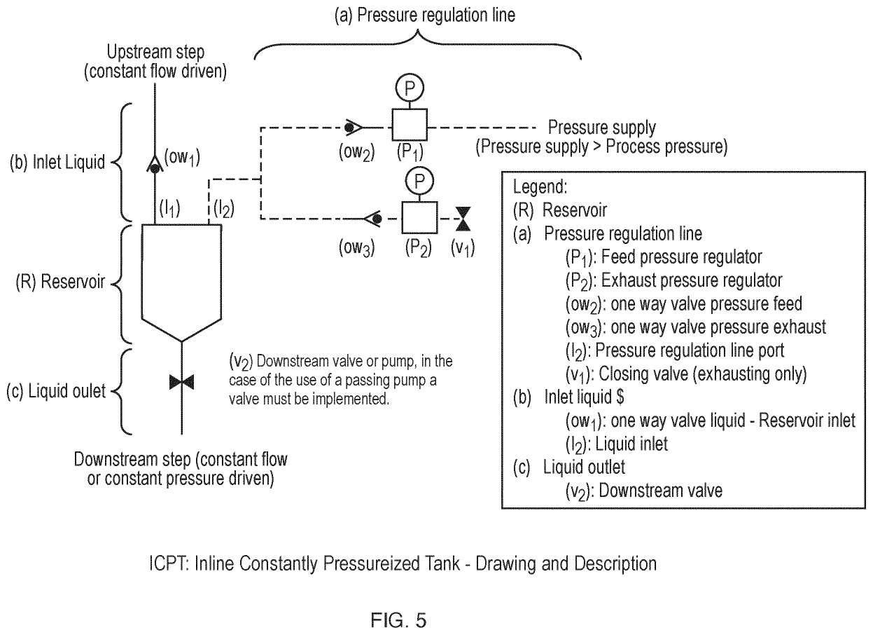

Assembly instruction. See, FIG. 5.
1) Set upstream step and connect it to the one way valve liquid (ow₁) which had to be subsequently connected to the liquid inlet (I₁) port of the ICPT-Inlet liquid (b) is assembled
2) Assemble the Liquid outlet (c) line and set a valve (v₂) in front of the downstream step. The valve can be replaced by a non-passing pump (as peristaltic for example)—this valve must be then closed to ensure system integrity
3) Connect the feed pressure regulator (P₁) to Pressure supply and add a one way valve (ow₂) just after, at the outlet of P₁. A T-connector can then be used to link the feed pressure supply to the Reservoir (R) and to the exhausting part of the pressure regulation line. An additional one way valve (ow₃) has to be added, and then followed by the second exhaust pressure regulator (P₂). A closed valve (v₁) has to be added just after this second pressure regulator. Then this line can be connected to the free port of the T-connector used to be connected to the inlet regulation line port (I₂) of the reservoir (R).
   Process Instruction. See, FIG. 5.
1) Prior use considerations: Verification that the system was properly assembled, integral, without any leaks. Ensured that the pump used can support the backpressure generated by the tank.
2) Turned on the pressure supply and set the feed pressure regulator (P₁) at the desired test pressure (for example, 30 psi).
3) Set the exhaust pressure regulator at the same pressure (i.e., here, 30 psi) and closed the valve (v₁).
4) Closed the valve (v₂)-Filling phase.
5) Upstream step was started, the tank was filled as process was proceeding, pressure was maintained constant with the pressure regulation line (a).
6) When enough volume was been accumulated in the tank (this volume/filling tank level has to be accurately known and previously determined), valve (v₂) was opened starting the downstream step.
7) The tank was filled, i.e., volume maintained, via the upstream step while downstream step was processed simultaneously.
8) If everything was operated properly, both steps will end simultaneously or substantially simultaneously (e.g., within seconds of each other).
9) Pressure supply can be switched off and system disassembled and/or sterilized.

### Results

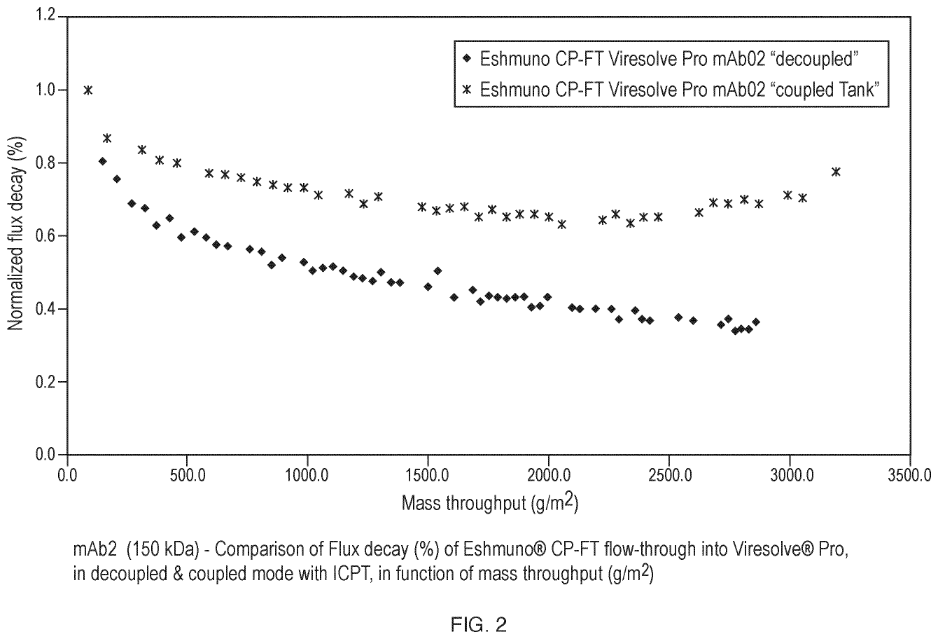

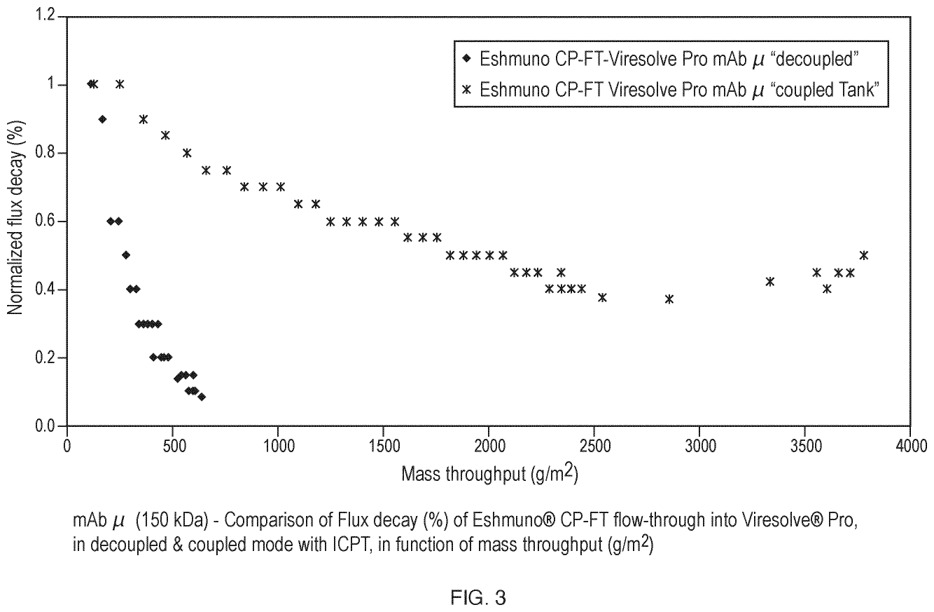

This process results in reduced process time and increased filter life thereby saving labor and material costs over known prior art processes. The results of exemplary runs are shown at FIGS. 2, 3 & 4.

FIG. 2 shows a graph of mass throughput (g/m²) of an fluid flow stream with exemplary monoclonal antibody mAb2 (150 kDa). The lower row of data points on the graph was generated via a decoupled setup that did not use the ICPT process and setup of the present invention. The upper set of data points shows a process run with a fluid flow stream having the same characteristics as with the decoupled setup however including the ICPT process of the present invention. As can be seen on the graph, flux decay was greatly reduced and mass throughput greatly increased over the decoupled process.

FIG. 3 shows a graph of mass throughput (g/m²) of an fluid flow stream with exemplary monoclonal antibody mAbu (105 kDa). The lower row of data points on the graph was generated via a de-coupled setup that did not use the ICPT process and setup of the present invention. The upper set of data points shows a process run with a fluid flow stream having the same characteristics as with the decoupled setup however including the ICPT process of the present invention. As can be seen on the graph, flux decay was greatly reduced and mass throughput greatly increased over the decoupled process.

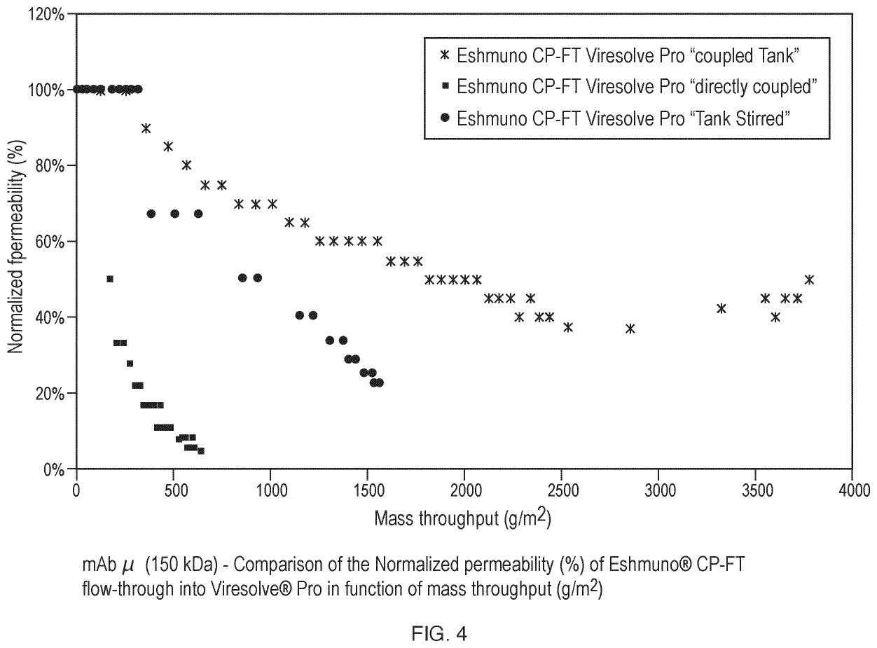

FIG. 4 shows a graph of mass throughput (g/m²) normalized permeability (LMH/psi) of ESHMUNO® CP-FT flow-through VIRESOLVE® Pro filters (MilliporeSigma, Bedford, MA) run in three modes. The lower row of data points (squares) utilized a decoupled process. The middle row of data points (circles) utilized a directly-coupled process and the upper row of data points (diamonds) utilized the ICPT process of the present invention. It can be seen that the ICPT process of the present invention resulted in greater mass throughput as compared to the control runs.

As can be readily seen from the results of these detailed experiments, the ICPT process of the present invention provides for a process that couples disparate process steps resulting in material, labor and space savings while at the same time resulting in greatly increased filer capacity.

What is claimed is:

1) A method for providing a constant pressure to a filter apparatus independent of a feed stream flow rate, said method comprising:
a) providing i) a reservoir comprising one or more fluid feed stream inlets and one or more fluid feed stream outlets and ii) a pressure source for providing and maintaining pressure in the reservoir while in operation, said pressure source comprising a both pressurized gas supply controlled by a pressure regulator and a pressure regulation valve located between, and in fluid connection with, said pressure regulator and said reservoir;
b) wherein the fluid feed stream enters the reservoir via the one or more fluid feed stream inlets at a flow rate;
c) wherein the reservoir is pressurized from gas supplied by the pressure source;
d) wherein constant pressure is maintained in the reservoir when said pressure regulation valve opens to bleed off excess pressure from the gas supply line if the pressure in the reservoir exceeds a first preset pressure or closes to allow gas from the gas supply line to enter the reservoir to maintain or raise the pressure in the reservoir if the pressure in the reservoir is at or below a second preset pressure;
e) wherein said fluid feed stream exits the reservoir via the one or more fluid feed stream outlets at approximately the same flow rate as when it enters the reservoir;
f) wherein said fluid feed stream is delivered at a constant pressure to one or more filters located downstream of the one or more reservoir outlets.

2) The method of claim 1, wherein the first preset pressure is lower than the second preset pressure.

3) The method of claim 1, wherein the gas supply is sterile.

4) The method of claim 1, wherein said gas supply gas is air.

5) The method of claim 1, wherein said first or second pressure is from approximately 4 bar and up to approximately 7 bar.

6) The method of claim 1, wherein said filter is a virus filter.

7) The method of claim 1, wherein said filter is a filter for sterilizing the fluid feed stream.

8) The method of claim 1, wherein said filter is a filter for concentrating the feed stream.

9) The method of claim 1, wherein the fluid feed stream entering the reservoir is continuous.

10) A method for filtering a fluid stream from an upstream process step, the method comprising:
a) providing i) a fluid feed stream to be filtered from an upstream process step, ii) a reservoir maintained at a substantially constant pressure when operated and iii) a filter apparatus located downstream of the reservoir;
b) said reservoir having i) one of more inlets for said fluid stream to enter the reservoir, ii) one or more outlets, iii) a pressurized gas supply and iv) a pressure regulation valve in fluid connection and located between the pressurized gas supply and the reservoir and, wherein said reservoir is maintained at a constant pressure independent of the flow rate of the fluid feed steam into the reservoir;
c) wherein constant pressure is maintained in the reservoir when said pressure regulation valve opens to bleed off excess pressure from the gas supply line if the pressure in the reservoir exceeds a first preset pressure or closes to allow gas from the gas supply line to enter the reservoir to maintain or raise the pressure in the reservoir if the pressure in the reservoir is at or below a second preset pressure;
d) said reservoir outlet being in fluid communication with the filter; and,
e) wherein said fluid feed stream from an upstream process step passes into said reservoir maintained at a constant pressure before being directed toward said filter apparatus.

11) The method of claim 10, wherein the first preset pressure is lower than the second preset pressure.

12) The method of claim 1, wherein the gas supply is sterile.

13) The method of claim 1, wherein said gas supply gas is air.

14) The method of claim 1, wherein said first or second pressure is from approximately 4 bar and up to approximately 7 bar.

15) The method of claim 1, wherein said filter is a virus filter.

16) The method of claim 1, wherein said filter is a filter for sterilizing the fluid feed stream.

17) The method of claim 1, wherein said filter is a filter for concentrating the feed stream.

18) The method of claim 1, wherein the fluid feed stream entering the reservoir is continuous.
